(19) United States
(12) Patent Application Publication
(10) Pub. No.: US 2007/0174770 A1
(43) Pub. Date: Jul. 26, 2007

(54) Time conditioned digital map and information display

(76) Inventor: Michael John Safoutin, Seattle, WA (US)

Correspondence Address: MICHAEL J. SAFOUTIN, 4137 UNIVERSITY WAY NE, APT. E, SEATTLE, WA, 98105, US

(21) Appl. No.: 11/656,140

(22) Filed: Jan. 20, 2007

Related U.S. Application Data
(60) Provisional application No. 60/760,442, filed on Jan. 20, 2006.

(51) Int. Cl. G06F 3/00; G08G 1/123

(52) U.S. Cl. 715/700; 340/995.1

(57) ABSTRACT

A time-conditioned digital map and information display method and apparatus includes establishment of a time condition applicable to composing the display, reference to time-related information associated with displayable items, identification of indicated state(s) or propertie(s) of said displayable items by means of evaluation of the time-related information relative the time condition, and depiction of said items in a manner that is determined at least in part by said indicated state(s) or propertie(s).

### CROSS-REFERENCE TO RELATED APPLICATIONS

This application claims the benefit of U.S. Provisional Application No. 60/760,442 filed Jan. 20, 2006.

### STATEMENT REGARDING FEDERALLY SPONSORED RESEARCH OR DEVELOPMENT

Not Applicable

### TECHNICAL FIELD

The present invention relates to geographic information displays, particularly digital mapping systems which provide a map display that represents the geographic location of real-world places.

### BACKGROUND OF THE INVENTION

A rapidly growing sector in the digital mapping art concerns the generation and display of digital maps that express information about mappable items, such as retail businesses or other geographically representable features, that are of interest to consumers in a local area. For example, a map might be generated showing roads and streets within a specified local area, and also the locations of retail businesses in that local area by means of graphic shapes or symbols placed upon the street network, and possibly a recommended travel route from a point of origin to or among the depicted retail businesses. In this way, any feature that exists in the real world may be considered a mappable item that may be depicted on the digital map by knowing little more than its geographic location within the coordinate system employed by the map display, and any other descriptive information necessary to label it on the map such that the representation of the mapped item may be distinguished from the representations of other mapped items. These prior art maps can be said to be successful in that they achieve a representation of mapped items that is expressive of their geographic location relative a frame of reference and, in the case of multiple mapped items, their geographic location relative to each other. Being digital rather than printed, these maps offer the additional advantage of being able to depict a variable number of features rather than a fixed set of features, perhaps in response to a search query or dependent on magnification level.

Despite these advantages of prior art digital maps, the real-world features depicted by them often possess additional information that is not so well expressed, although it is of strong interest to consumers or other users of such a map. It is obvious to anyone skilled in the art that, presented with geographical information associated with a mappable item, such as its latitude and longitude, or its street address, the geographical information may be expressed visually and graphically by employing it to determine a location on the map grid upon which to plot a predetermined representation of the item, such as a standard shape or symbol. It is also obvious that additional descriptive information that is not necessarily geographically locative in nature, such as the name of the item, or a category to which it has been assigned, or a textual representation of its address, might also be expressed on a map by means of a label or symbol placed near the plotted representation of the item. Alternatively as is often the case a hyperlink may be provided instead of or in addition to such a label, upon which the user of the map may hover the mouse or click the mouse to reveal additional information by means of an auxiliary display element such as a pop-up window or a sidebar display. Said auxiliary display element thereby often serves as the sole means of communicating to the user any additional information about the item that its plotted location does not make self evident.

A particularly important example of said additional information relevant to the above discussion is time-related information. Specifically, time-related information in the context of this discussion is defined as any information associated with a mappable item that acts to relate one or more predictable states or properties of the item to time. In the following discussion, “states” are defined as mutually exclusive attributes of an item. For example, states associated with an item that is a retail business might include the mutually exclusive binary pair “open” and “closed”, or the mutually exclusive triplet “open”, “closed”, and “by appointment only”. Properties are defined as non-mutually-exclusive attributes of an item. That is, an item may simultaneously possess one or several properties. For example, some properties associated with a retail business might include “non-smoking”, “discount”, “allows pets”, and “has restroom”. In most cases, in the following description, that which applies to states also applies to properties and vice versa.

A particularly familiar example of such time-related information is the hours of operation, or business hours, of a retail or service business. Such a business typically keeps a regular schedule of time periods, usually expressed on a weekly basis upon which the schedule repeats, during which the business is open to customers, all other time periods being closed to customers or possibly open only by special appointment. The purpose for the business to schedule such hours, and by extension the goal of a digital map or other information display in communicating information expressive of such a schedule, is to provide potential customers, or users of said map or information display, the ability to determine the availability of the products or services offered by the business at any random time that may be of interest to the user. That is, typically the user when using such a map or information display has a specific time or time period in mind during which he or she may be interested in doing business with one or more depicted businesses. The user then has an interest in determining the scheduled availability of the business relative the time or time period in mind, with the least possible expenditure of cognitive effort.

Prior art representations of such schedule information have been limited to literal, descriptive representations such as “Business hours: 9 am-5 pm, Monday thru Friday”, or at best a list or table of days of the week accompanied by a textual description of the corresponding opening and closing time for each day. This format, in which every scheduled period of availability and inavailability is expressed, is necessary because the provider of the information display has no way of knowing which specific time of interest a given user may have in mind when the display is viewed. Unfortunately, the generality of this method of representation leaves to the viewer the cognitive task of bringing a specific time of interest into consideration, and processing it relative to the provided schedule information in order to determine availability of the business relative said time of interest. Even when said time of interest is simply the current time and date, the cognitive task imposes significant burden and is prone to error for all but the simplest schedules.

Many other examples of time-related information also suffer from similarly inadequate representation in prior art digital maps. For example, it is known in the art that scheduled events that occur on a one-time or repeating basis may be generally depicted on a map by simply plotting their geographic location of occurrence. Given such a depiction, the viewer may wish to determine the status of the event in terms of criteria such as whether the event occurs in the future, is happening now, or is past; and if future or past, relatively how far in the future or past, all relative to a given time condition. Unfortunately, this depiction provides the user with only the geographic location of the event and does not directly communicate the scheduled time or duration. The user typically must open an auxiliary window or hyperlink in order to determine the actual time of the event, and in so doing is again faced with the cognitive task of comparing a time of interest to the scheduled time of the event. While it is obvious that the designer of the map display might practice a simple type of time-conditioning by restricting the display of events to show only future events and not past events relative the current time, this does nothing to directly communicate how far in the future an event is scheduled to take place, or whether an event is currently underway. Furthermore, the nonrepresentation of past events on the map has a negative side effect in that past events cannot be accessed in the same manner as other events. This presents an unnecessary obstacle to accessing past events for useful purposes such as posting a review of the event or accessing historical information about the event. It can now be seen that prior art digital map representations of events do little if anything to directly convey these time-related aspects for the purpose of relating possible states or properties of an event to a time of interest, or for comparing the time conditioned status of several events to each other.

As another example, items to be mapped might possess information representing intervals of existence or nonexistence as a function of time. For example, features that in real life have impermanent existence, such as retail businesses, or buildings, or landscape features, or any other feature that might exist during a given historical time period but not during other time periods, may be described by means of time-related information representing time points such as the date on which they began existence, and/or the date on which they ceased to exist. While in the prior art it is known to associate a general date of applicability of a map depiction (such as in an edition date or revision date) in order to suggest a period in time with which the implicit existence or nonexistence of items depicted or not depicted may be associated, such depictions cannot directly communicate temporal recentness, remoteness, or simultaneity of said existence.

As still another example, items to be mapped might include features that translate or rotate (i.e. move) in geographic position as they travel along a scheduled route, thereby possessing time-related information describing this movement as a function of time. For example, a city bus that travels along a scheduled route would be a mappable item that varies in scheduled position as a function of time. Prior art digital maps generally do not provide for any function to allow changing position of mapped items over time.

This discussion has made it clear that prior art digital maps are not equipped to depict time-related information effectively. In order to do so, they would need to establish and employ a time condition such that time-related information associated with mappable items could be evaluated relative the time condition, and then the items depicted in a manner dependent upon, and thereby expressive of, the indicated item state or item property that corresponds to the time condition.

In recent years the prior art has expanded to include many mass-market examples of maps generated on demand, particularly by means of an internet web browser acting through an internet connection to a map service provider. These applications do not provide for the specification of, nor do they employ, any explicit or implicit time condition in composing the map, and instead merely compose a map of static items in a static representation regardless of the time at which the display was requested or composed. Some examples are the maps typically provided by internet web sites such as Yahoo!, Mapquest, and Google.

Some prior art maps, however, go somewhat beyond a purely static depiction and display changing content. For example, today the average internet user is likely to be aware of traffic maps that display a map of local highways composed with variable coloration or other modifications indicating the current state of traffic at various points or stretches along the highways. However, in doing so these maps depict current information representing actual states or properties, typically gathered by means of automatic sensors or human observation of actual conditions. They do not anticipate the use of time-related information as described herein, in which the time-related information is representative of a state or property of an item predictable as a function of time. In other words, traffic maps and similar sorts of maps do not depict states or properties as a function of time per se, but rather they merely possess the ability to depict actual observed states or properties at a given time. As a similar example, a weather map that shows the current weather conditions over a geographic area also does not depict states or properties as a function of time, but merely depicts actual observations at a given time. And while it is known in prior art digital maps to portray the actual location of, for example, a city bus as determined by a radio beacon or other location sensing device, it is not known to depict the scheduled location of such an object by reference to route schedules or other similar schedule information. While it is arguable that the former portrayal is more useful to a bus rider than the latter, the latter portrayal would be no less useful than a printed bus schedule of the sort that is widely distributed by any city bus system. The latter portrayal would also have the advantage of providing a graphic depiction of schedule information in real time, as an alternative to a textual depiction. The latter portrayal is also useful as a way of simulating the movement of real world features on a digital map while not requiring any beaconing or sensing technology.

Furthermore, maps of the prior art do not provide a time specification means by which the user may specify a time in the future or past by reference to which the map should be composed. Likely this is due to the fact that in prior art applications, it is rightfully expected that the user would have little or no interest in, for example, past weather conditions or past traffic conditions; and similarly, the ability to accurately predict and therefore seek to express future such conditions is limited and unreliable. However, in the case of mappable items that possess time-related information that allows reliable prediction of scheduled states or properties as a random function of time, the provision of a time control interface becomes a new and useful innovation that dramatically improves the usefulness of the digital map to the user.

Another possible explanation for the absence of a time condition in prior art digital maps may be due to the fact that maps in general are traditionally understood as a means of representing two- or three-dimensional information of a geometric, spatial nature and as such do not naturally suggest the applicability of time information to the task of composing a map. Even the prevailing state of the art in digital maps, which are not static in nature as are printed maps, do not establish nor employ a time condition toward the goal of converting time-related information to indicated state(s) or propertie(s) associated with the time condition and employing said indicated state(s) or propertie(s) in determining a manner of depiction for items on the map.

Therefore it is submitted that time-related information possessed by mappable items, while today being communicated on digital maps (if at all) primarily by auxiliary means such as a label or a link to an auxiliary information display means, would be more effectively expressed by other means that are not so obvious to one who is primarily and understandably oriented toward employing only locative and textual information for use in composing the map display depiction of a mappable item. That is, by an appropriate means and method to be disclosed herein, it is a new and useful improvement of the digital mapping art to provide for the use of time-related information in influencing the choice of manner of depiction of mapped items, thereby communicating such information directly on the digital map, and reducing the cognitive effort necessary to comprehend such information.

### BRIEF SUMMARY OF THE INVENTION

This application for patent describes a time-conditioned digital map and information display method and apparatus, which provides for depiction of mapped items in a manner that is determined at least in part by evaluation of a time condition relative time-related information associated with mapped items.

A method for composing the display of a digital map includes establishment of a time condition comprising one or more reference time(s) or time period(s) by reference to one or more known current time(s) or other established time(s) or time period(s), or alternatively by reference to a time control user interface; said time condition is employed in composing a digital map display so as to express on said map display, by means of manner of depiction of mapped items, their indicated state(s) or propertie(s) corresponding to said time condition; said correspondence being indicated by evaluation of time-related information associated with mappable items with respect to said time condition; said time-related information being information that relates specified, implied, or default state(s) or propertie(s) of said mappable items to specified, implied, or default representation(s) of time.

A time conditioned digital map and information display apparatus includes a digital map display; means for storing and thereby associating a specified, implied, or default time condition with the map display and/or any instance of composing the map display; a database of one or more mappable item(s), said database including time-related information relating one or more specified, implied, or default state(s) or propertie(s) of one or more mappable item(s) to one or more time point(s) or time period(s) within one or more specified, implied, or default time domain(s), evaluating means for evaluation of said item time-related information relative to said time condition, and representation means for depiction of said mappable item(s) on said map display in a manner dependent upon result of said evaluation. Optionally, means may be provided for a user or viewer of the map display to specify one or more time point(s) or time period(s) whereby said time condition to be associated with the map display may be established.

The theory of operation of the invention is centered on the recognition that time-related information, particularly that which is descriptive of one or more states or properties predictable either deterministically or probabilistically as a function of time, may upon provision of a time condition, such as for example the current time or any other point in time or period of time, be used to identify the one or more indicated or probable states or properties that the time-related information indicates as corresponding to said time condition. The state(s) or propertie(s) thus indicated as corresponding to the time condition, and/or any indicated probabilities connected to said indicated states or properties, might then be employed in determining a representation of said item that is expressive of said state(s) or propertie(s) (and/or probabilities thereof) and which thereby may be successfully and effectively communicated by means of the digital map display, without reliance on a textual label or other auxiliary means.

The invention also recognizes that providing a way for the user or viewer of a digital map or other information display the ability to specify a time condition makes it possible for the availability of goods and services, scheduled events, or the location of moving items, at a given time to be determined and expressed directly on the digital map display. Furthermore, the invention recognizes that a suitable time condition is normally available to the computer that generates the map display, in the form of a current system time, which in many cases is sufficient to employ as a default time condition for the purpose of informing the viewer about the current state or property of given items.

Furthermore, the invention recognizes that the computing power of the computer driving the digital map display may be used to derive additional information in evaluating the relationship between the time condition and the time-related information, such as for example the amount of time remaining in the indicated state, and also then employed in determining an appropriately expressive representation to be depicted.

A preferred embodiment of the invention is described as follows. A map display is provided upon which mappable items may be depicted in terms of their geographical location as represented by geographical information, such as latitude and longitude for example, and in terms of their state(s) or propertie(s) expected to correspond to a time condition consisting of current system time or a time or time period specified by a time control. Specifically, the digital map display is part of a digital mapping computer program system installed on a desktop computer, but it could alternatively be a world-wide-web-based digital mapping system that serves maps to web browsers by means of a digital mapping engine that runs on one or more web server computers connected directly or indirectly to the internet.

Database elements in a database representing one or more mappable items include time-related information representative of scheduled time intervals during which one or more specified states or properties of the item pertain. For example, mappable database items that represent retail businesses might contain time-related information that represents their hours of operation, regularly scheduled sale periods, happy hours (that is, drink specials valid at a given time of day on a given day of the week), employee work shifts, or any other information describing states or properties as a function of time. Other types of mappable items include scheduled one-time, or repeating, events that occur at specific geographic locations (for example, at the locations of said retail businesses, or at other locations). Examples of such events might include band appearances, or even employee work shifts, happy hours, and many other types of events.

Said time-related information included with mappable items might, for example, consist of a representation of time intervals during a specified, implied, or default time basis (such as for example a calendar week) in which a specified, implied, or default state (such as “open” or “closed”, or “on sale” or “not on sale”) are scheduled to apply, and upon which cycle said time intervals repeat. For example, hours of operation (i.e. business hours), for items for which such hours are known and represented in the database, may be expressed in terms of a weekly repeating schedule of opening and closing times expressed in minutes past a base reference time such as 12:00 AM Monday. Repeating events may be described in a way like that employed for business hours. One-time events may be described in terms of a start time and an end time relative a fixed time reference point such as for example Jan. 1, 1900.

For mappable items possessing time-related information describing business hours, applicable states are represented by a binary pair representing “open” (business is open to the public for business) and “closed” (business is closed to the public for business). Alternative states representing “unknown” or “by appointment” may be assigned programmatically if the time-related information is unavailable or insufficient to identify either of the binary states as corresponding to the time condition, or if the time-related information indicates that the business does not hold regularly scheduled business hours but does offer the opportunity to conduct business by appointment, respectively. Applicable states for events include “happening in the future”, “happening now”, and “happened in the past”.

A time control user interface is provided by which the viewer of the digital map may optionally specify a time condition consisting of a first time point and optionally a second time point (i.e. optionally a time interval) within historical (i.e. ordinary clock and calendar) time. Said time points may be represented at any appropriate degree of precision, such as in the form of a “day-month-year”, or “day-month-year-time of day”. In the absence of a user specification by means of the time control, the time condition is the computer system time at time of composition of the map display, localized if necessary to a local time corresponding with the locality of the business. The time condition is expressed as a weekly schedule time in minutes relative to a reference time defined for the weekly schedule style (for example, 12:00 AM Monday).

Prior to depicting a mappable item on the digital map display, an evaluation of its time-related information relative the time condition takes place, resulting in the identification of at least one item state or item property indicated as corresponding to the time condition. The mappable item is then depicted visually in a fill color predetermined as corresponding to said indicated state(s) or propertie(s), thereby expressing said indicated state(s) or propertie(s) of the mappable item at the time represented by the time condition. Alternatively, a medium other than fill color may be employed, such as line color, fill and line color both, variation in depicted shape, textual annotation, animation in shape or color, or any other means applicable to a computer screen display.

By providing a time condition to be applied to the determination of a manner of depiction for mappable items that possess time-related information, the invention provides a way for a digital map to represent time-related information without the need for textual labels which may clutter the display, or the need for an auxiliary display element reactive to mouseover or mouse click, and which in either case would require significant cognitive effort to read and interpret. One important advantage of the invention therefore is in reducing the cognitive effort required of the map user to determine the scheduled state or property of the items depicted on the information display relative to a given time(s) of interest, while retaining the advantages of the geographic representation afforded by the digital map medium.

By relying on time-related information representing scheduled times and their associated states or properties, rather than states or properties gathered in real time by actual observations, the invention dramatically reduces the cost and sophistication of technology necessary to achieve a dynamically changing representation of a real neighborhood or other geographic area as it changes over time.

### BRIEF DESCRIPTION OF THE SEVERAL VIEWS OF THE DRAWING

FIG. 1 depicts a digital map display such as might be provided in the prior art, in which mappable items are depicted without depicting states or properties conditional upon a time condition.

FIG. 2 depicts a digital map display in which a default time condition has been enabled and items have received a differential manner of depiction resulting from evaluation of item time-related information relative the time condition.

FIG. 3 depicts a digital map display in which a time condition has been explicitly specified, resulting in a change in the manner of item depiction.

FIG. 4 depicts a digital map display in which the time condition has been changed to a different time of day, resulting in a change in the manner of item depiction.

FIG. 5 depicts a digital map display in which the time condition has been changed to a different date, resulting in a change in the manner of item depiction.

FIG. 6 depicts a digital map display in which the time condition has been specified as a time interval, resulting in a change in the manner of item depiction.

FIG. 7 depicts a digital map display in which events are depicted in a manner conditional upon a specified time condition.

FIG. 8 depicts a digital map display in which the time condition has been changed to a different date, resulting in a change in the manner of depiction of items.

FIG. 9 depicts a digital map display in which the time condition has been changed to a still different date, resulting in still another change in the manner of item depiction.

FIG. 10 depicts a digital map display in which the time condition has been changed yet again, resulting in still another change in the manner of item depiction.

FIG. 11 depicts a digital map display in which the time condition has been specified as a time interval, resulting in a change in the manner of item depiction.

FIG. 12 shows an example of a data representation by which time-related information associated with a mappable item may be represented.

FIG. 13 details several portions of the data representation depicted in FIG. 12.

### DETAILED DESCRIPTION OF THE INVENTION

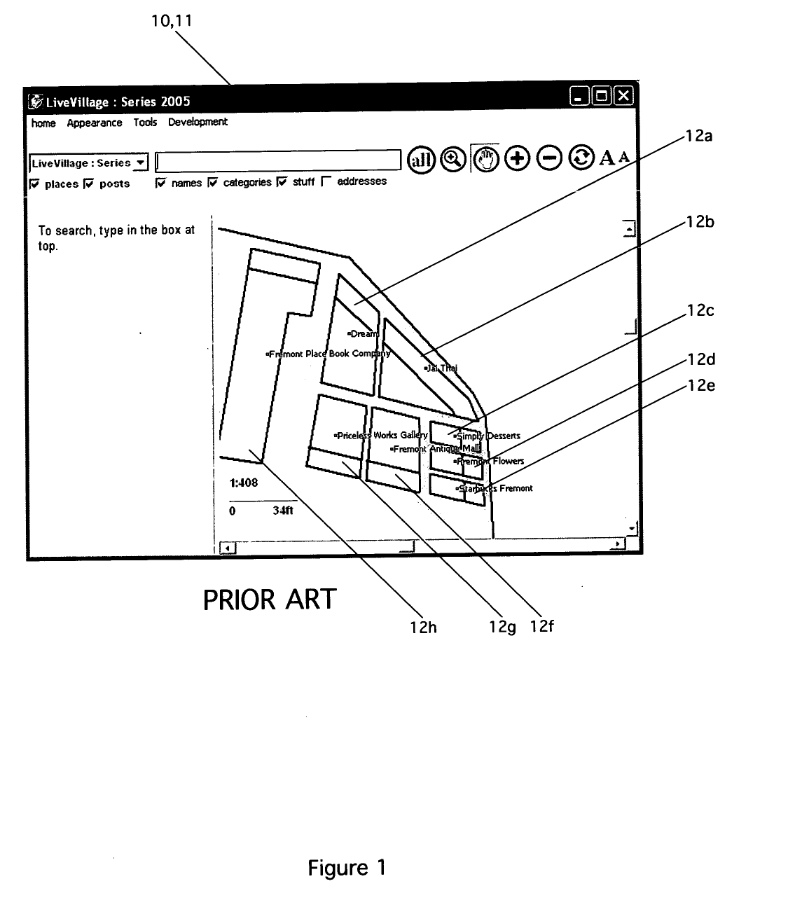

Referring to FIG. 1, a map display 10 such as might be found in the prior art includes an ordinary user interface window 11. It may be seen that this window/map display possesses standard interface elements such as title bar, scroll bars, and content area (unlabeled because they are common in the art). Additionally may be seen additional interface elements, also unlabeled, that provide standard tools such as search, database specification, view navigation such as pan and zoom, and similar interface features as might be provided on any digital map interface. Upon the content area are depicted retail businesses 12a-12h by means of, for example, simple geometric shapes. It may be seen that all of these retail businesses 12a-12h are painted in a similar line color, line thickness, and fill color. Here they are also (optionally) labeled with their respective business names. In the prior art map display depicted in FIG. 1, no time-related information has been employed in composition of the map display, and no time condition pertaining to the manner of depiction has been recognized or employed. Therefore, despite a natural expectation that retail businesses 12a-12h are each likely to adhere to a regular schedule of business hours, it may be seen that no differentiation based upon indicated states or properties of businesses 12a-12h relative a time condition is provided in the manner of depiction of businesses 12a-12h, and they all appear similar.

Now suppose that time-related information is possessed by some of the items 12a-12h. Specifically, suppose that the information indicates the following open/closed schedules apply:
12a: open 10 am-8 pm Monday thru Thursday; 10 am-9 pm Friday; 10 am-8 pm Saturday; 10 am-7 pm Sunday; all other times closed.
12b: open 11 am-1 am Monday thru Friday; 7 am-1 am Saturday and Sunday; all other times closed.
12c: no information available.
12d: open 9 am-6 pm Monday thru Friday; 10 am-2 pm Saturday; all other times closed.
12e: no information available.
12f: open 11 am-7 pm Monday thru Friday; 10 am-7 pm Saturday and Sunday; all other times closed.
12g: open 12:00 noon-6 pm Thursday thru Sunday, all other times closed.
12h: open 10 am-8 pm Monday thru Tuesday; 10 am-9 pm Wednesday thru Saturday; 10 am-6:30 pm Sunday; all other times closed.

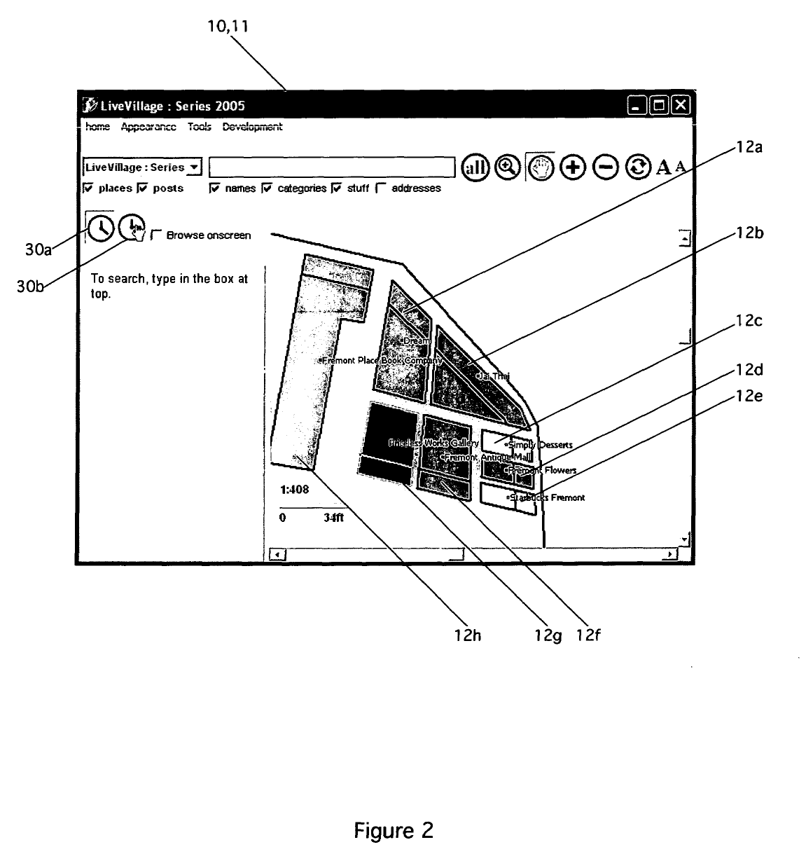

Referring now to FIG. 2, it may be seen that two additional interface elements are provided. Specifically, control element 30a and control element 30b are provided as interface buttons having mutually exclusive activation states, such that only one button may be pressed down at a given time. Control elements 30a and 30b, if either is activated, establish a mode in which the digital mapping program is directed to cause a time condition to be employed in determining a manner of depiction for items 12a-12g. Control element 30a, if activated, directs the program to employ a time condition in the form of a current system clock time. Control element 30b, if activated, directs the program to employ a user specified time condition as will be described later.

In the depicted control element state shown in FIG. 2, control element 30a is active and therefore the program, either upon activation of element 30a or upon the next redrawing opportunity, will establish a time condition in the form of a current system clock time, and employ a manner of depiction for each mapped item 12a-12h that is based upon the indicated state or property of each said item at that time condition. Suppose for example that the current system clock time, and therefore the time condition, is Wednesday, Jan. 18, 2006 at 12:07 pm. Now it may be seen that in FIG. 2, many of items 12a-12h differ in their manner of depiction from that of FIG. 1. Specifically, items 12a, 12b, 12d, 12f, and 12h have been composed with a darkened fill color; item 12g has been composed with an even darker fill color, and items 12c and 12e have been composed with a relatively light or undarkened fill color. Referring again to the open/closed schedules provided above, it can be seen that items 12a, 12b, 12d, 12f, and 12h received the intermediate darkened color because they possess time-related information which upon examination was found to indicate that at the established time condition their indicated states are “open”. Item 12g received the more darkened color because it possesses time-related information which upon examination was found to indicate that at the established time condition its indicated state is “closed”. Items 12c and 12e received a different coloration, assumed here for example to be an undarkened coloration, because they do not possess time-related information and so could not be assigned an indicated state or property based upon the time condition. It should be noted that the specific manners of depiction illustrated here, that is, of relative darkening or nondarkening of a fill color to express indicated state, is for purpose of example only, and many other alternative schemes could easily be employed within the scope of the invention. For example, line weights, line colors, fill colors, fill patterns, alternative geometric shapes, modifications of geometric shapes, superimposed symbols, superimposed text description of indicated state or property, animation sequences, and any other means of variation within the art of computer graphic composition might be employed to represent the differentiation in indicated state or property of mapped items that the invention is concerned with achieving.

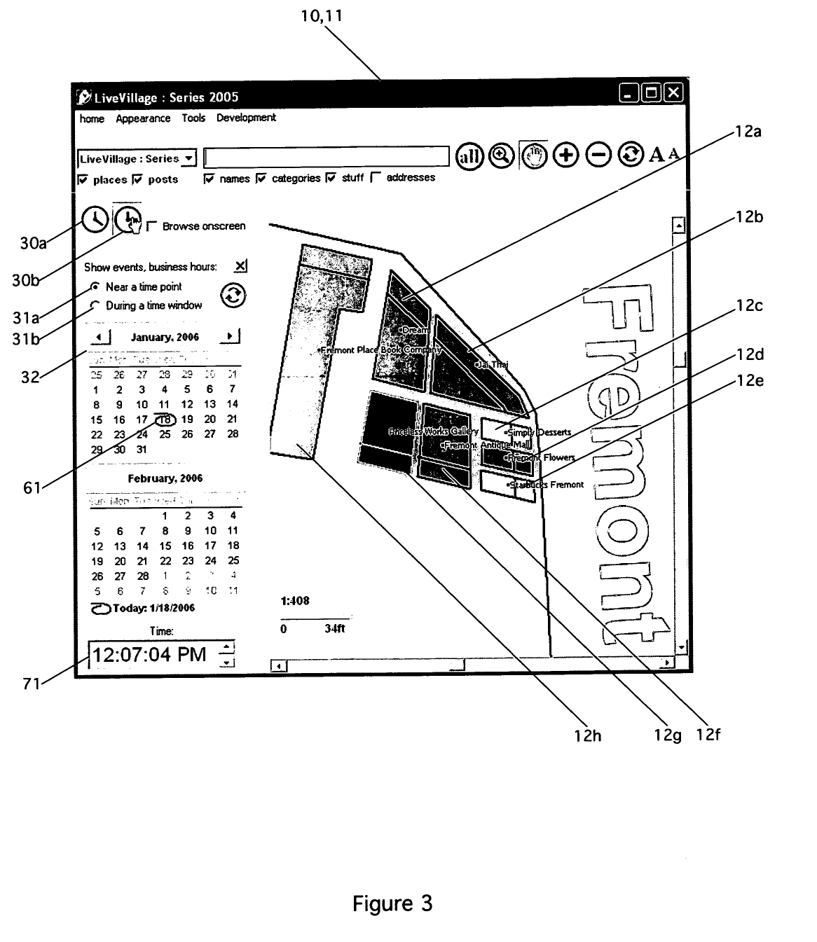

Referring now to FIG. 3, control element 30a is no longer active and instead control element 30b is active. This has caused additional control elements to become available. Elements 31a and 31b are radio buttons that specify the type of time condition to be defined, that is, either a time point (31a) or a time period (31b). Here the “time point” option is active (31a). Elements 32 and 71 are provided for the purpose of user specification of date and time. Specifically, date selector 32 allows specification of a date, and time selector 71 allows specification of a time of day. It may be seen that date selector 32 is set to a date of Wednesday Jan. 18, 2006 and time selector 71 is set to the time 12:07:04 pm. In this example, we assume that these times are the same as the “current time” that was employed in creating the depiction of FIG. 2. As a result, the selection of this mode has not changed the time condition from that employed in FIG. 2, and the manner of depiction of mappable items 12a-12h have not changed.

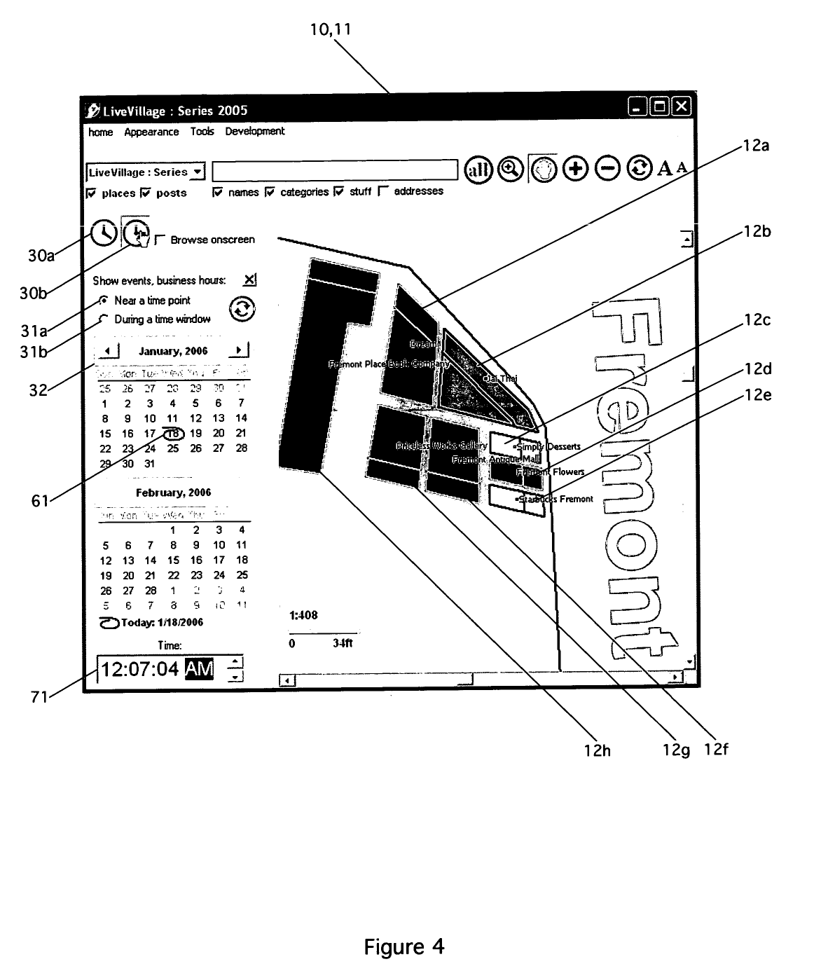

Referring now to FIG. 4, control element 30a, 30b, 31a, 31b, and 32 remain in an unchanged state, but time selector 71 has been changed to a different time (12:07:04 am). It may be seen that, owing to the change in the time condition from an early afternoon time of day (12:07:04 pm) to a late night/early morning time of day (12:07:04 am), many of the mapped items 12a-12h have changed in their manner of depiction. Specifically, items 12a, 12d, 12f, 12g, and 12h have been depicted in a more darkened color to indicate that they are closed at the time represented by the time condition. Item 12b has not changed from its previous “open” depiction because its time-related information indicates that it is also open at the late night/early morning time represented by the time condition. As would be expected, the absence of time-related information associated with items 12c and 12e prevent these items from receiving a different manner of depiction resulting from change in the time condition.

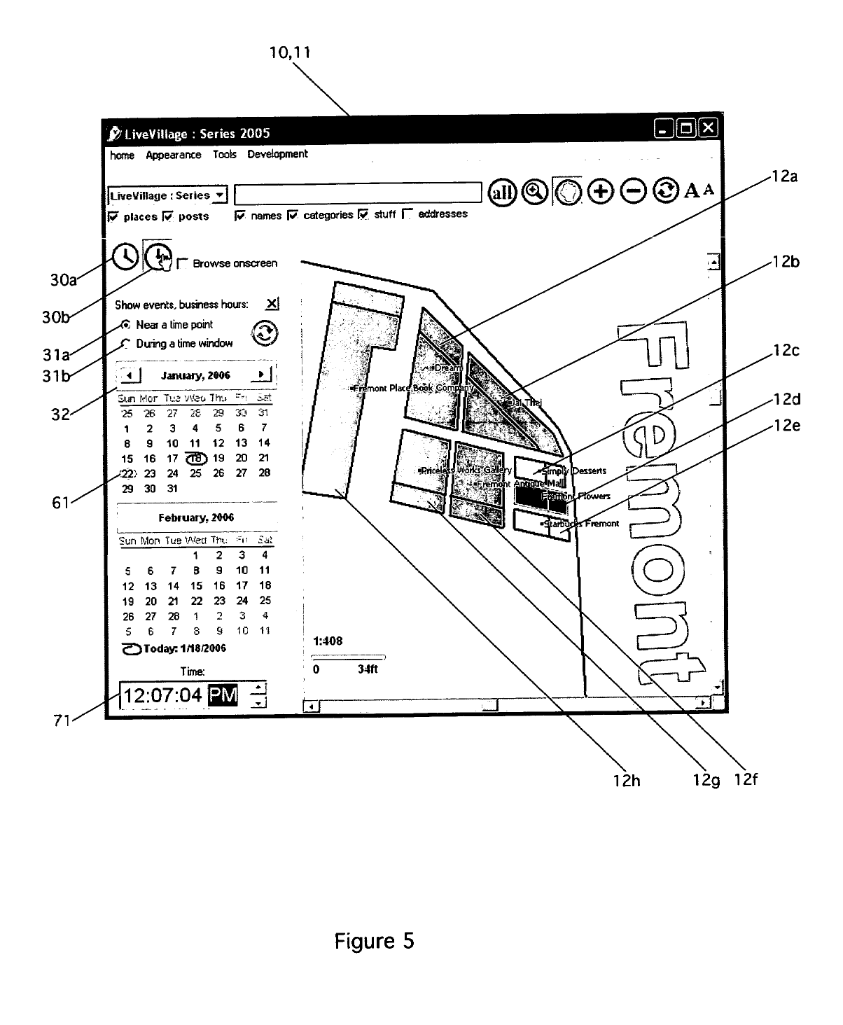

Referring now to FIG. 5, all control elements remain unchanged, except date selector 32 has changed to a different date (Sunday Jan. 22, 2006) and time selector 71 has changed to a different time of day, in this case, the original early afternoon time of day (12:07:04 pm). Similarly to the previous figures, several of items 12a-12h have changed in their manner of depiction in response to the change in indicated state resulting from the change in time condition. It may be seen that item 12d, which was depicted in a manner indicating an “open” state in FIG. 3 (weekday, early afternoon) and a “closed” state in FIG. 4 (weekday, early morning), remains depicted in a “closed” state because its time related information indicates that it is not open on Sundays. For similar reasons items 12a-12b and 12f-12h are depicted in an open state, and again, items 12c and 12e are unchanged.

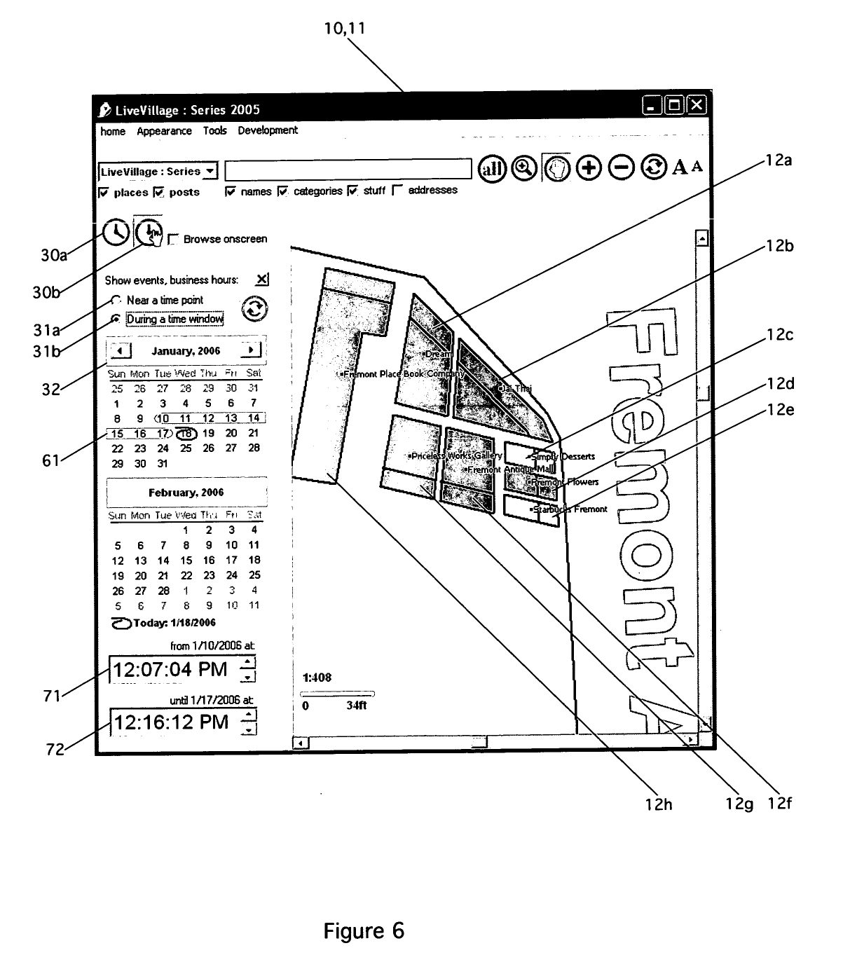

Referring now to FIG. 6, control element 31a (time point option) is no longer active, and instead control element 31b (time period option) is active. This mode causes the program to evaluate a time period as the time condition, rather than a single time point. A time period is defined in terms of a starting time and an ending time, that is, two times must be specified. For this reason, an additional time selector 72 has been provided. Time selector 72 has been set to 12:16:12 pm, and date selection indicator 61 indicates that a roughly week-long range of several days has been selected, beginning on January 10 and ending on January 17. These actions have defined a time period beginning on Jan. 10, 2006 at 12:07:04 pm and ending on Jan. 17, 2006 at 12:16:12 pm, causing this time period to be established as the time condition. It may be seen that all of the businesses 12a-12h for which time-related information is available (that is, all except 12c and 12e) are depicted in a moderately darkened state indicating “open” status. This is an expected result because businesses typically schedule their business hours on a cycle that repeats weekly, and therefore all such businesses will necessarily be scheduled for at least some open time during any week-long period.

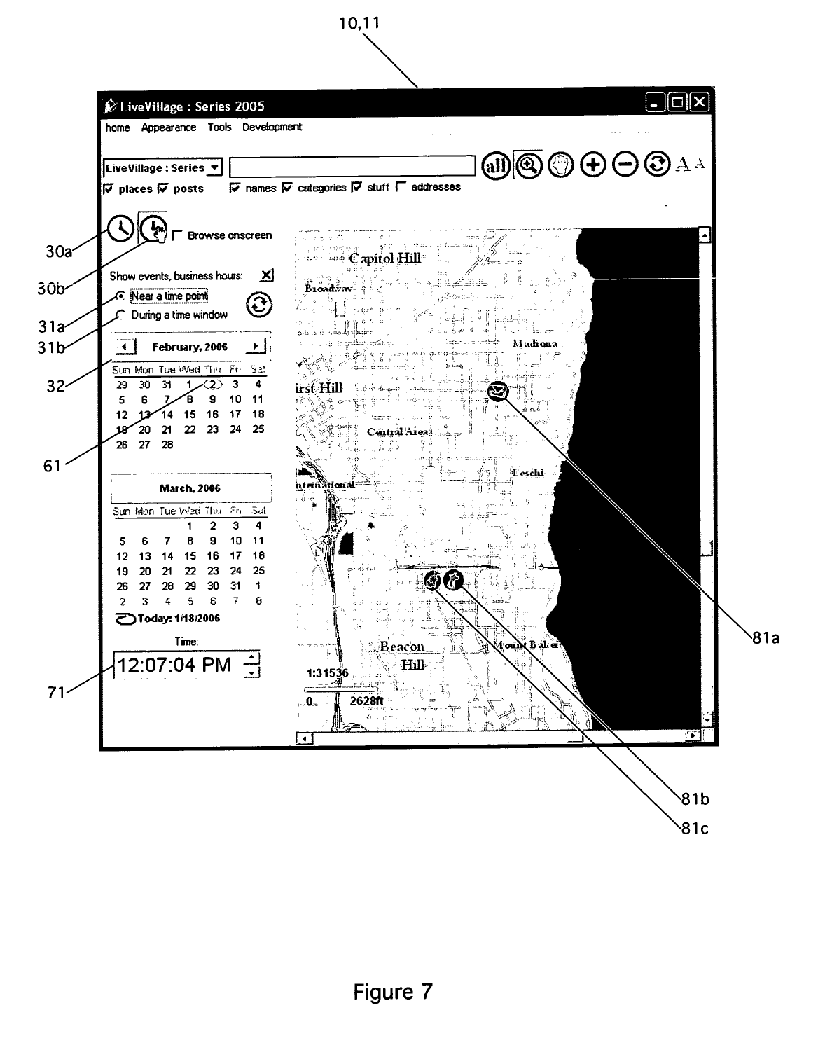

FIGS. 7-11 provide an example of how events rather than businesses might be depicted on a digital map according to the manner of operation of the invention. In FIG. 7, mappable items 81a-81c are events, having repeating or one-time occurrence as well as a geographic location. They are seen depicted on map display 10 in their respective geographic locations of occurrence as represented in the map database.

Suppose that the time-related information associated with events 81a-81c indicates that they have the following one-time periods of occurrence:
81a: begins 7 pm on May 5, 2006; ends 11 pm May 5, 2006.
81b: begins 12:00 noon on Feb. 9, 2006; ends 1 pm Feb. 9, 2006.
81c: begins 12:00 noon on Feb. 16, 2006; ends 1 pm Feb. 16, 2006.

Referring now to FIG. 7, the time condition is set to a time point defined as Feb. 2, 2006 at 12:07:04 pm. At this time condition, events 81a-81b are all found to be scheduled for future dates relative the time condition. For this reason all are depicted in a manner that represents future status. In this example, future status is depicted by means of a light colored symbol on a black circular background, one of many conceivable and similarly effective means of depiction that could be employed.

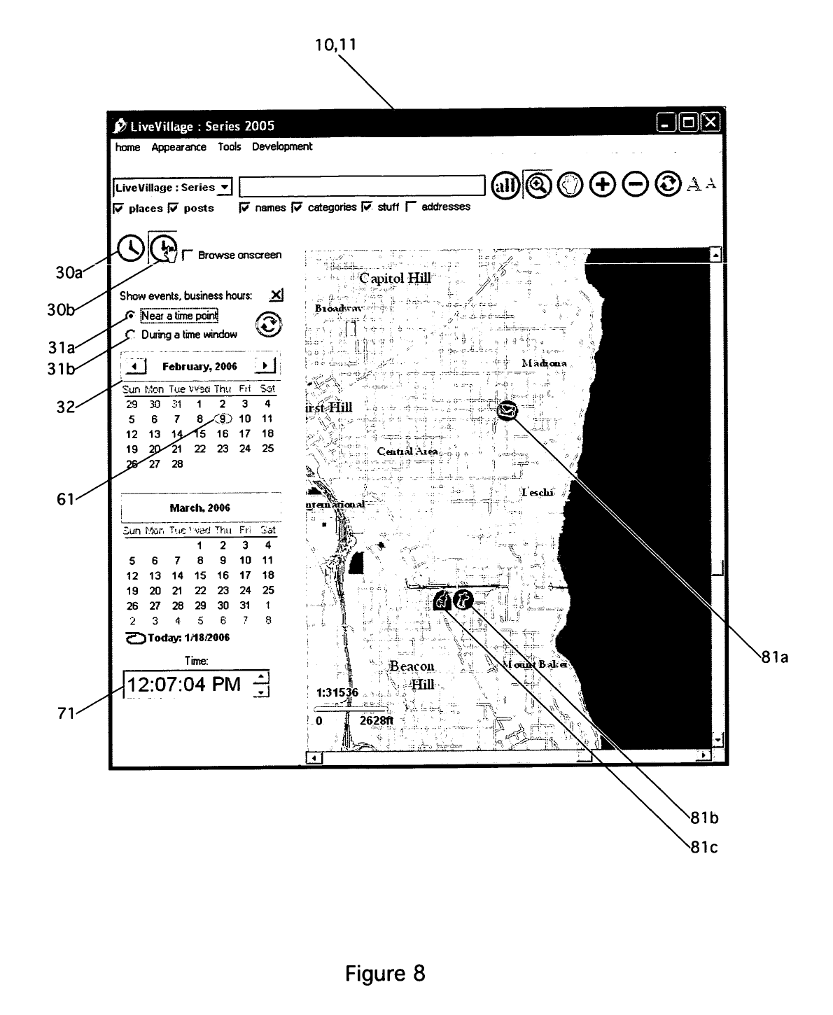

Referring now to FIG. 8, the time condition has changed to a time point on Feb. 9, 2006 at 12:07:04 pm. Items 81a and 81b continue to be indicated as future events, while item 81c has received a different manner of depiction because it has been found to be in occurrence at the time condition. Here, for example, the depiction of an event that is in occurrence at the time condition is depicted by means of a light colored symbol in a black circle with a squared bottom, one of many conceivable and similarly effective means of depiction that could be employed.

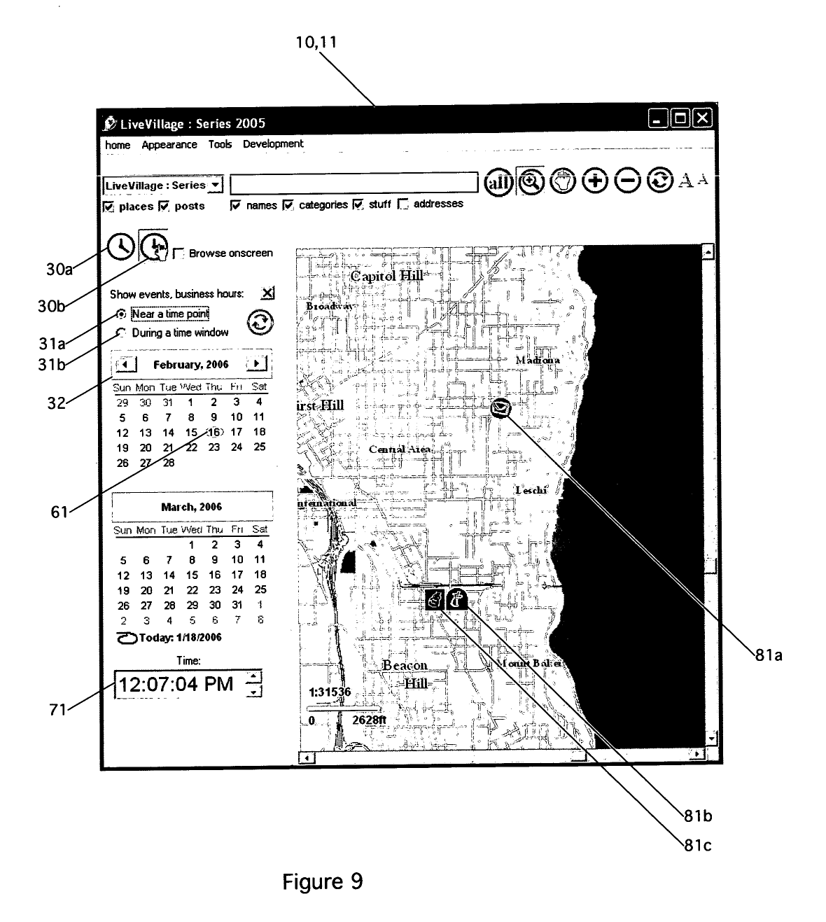

In FIG. 9, the time point has advanced to February 16. Relative to this time condition, event 81a is still a future event; but event 81b is in occurrence, and event 81c is in the past. Therefore event 81a remains unchanged in its manner of depiction; event 81b has changed to an “occurrence” depiction, and event 81c has changed to a “past” manner of depiction, which in this example is illustrated as a darkened symbol on a square black background, one of many conceivable and similarly effective means of depiction that could be employed.

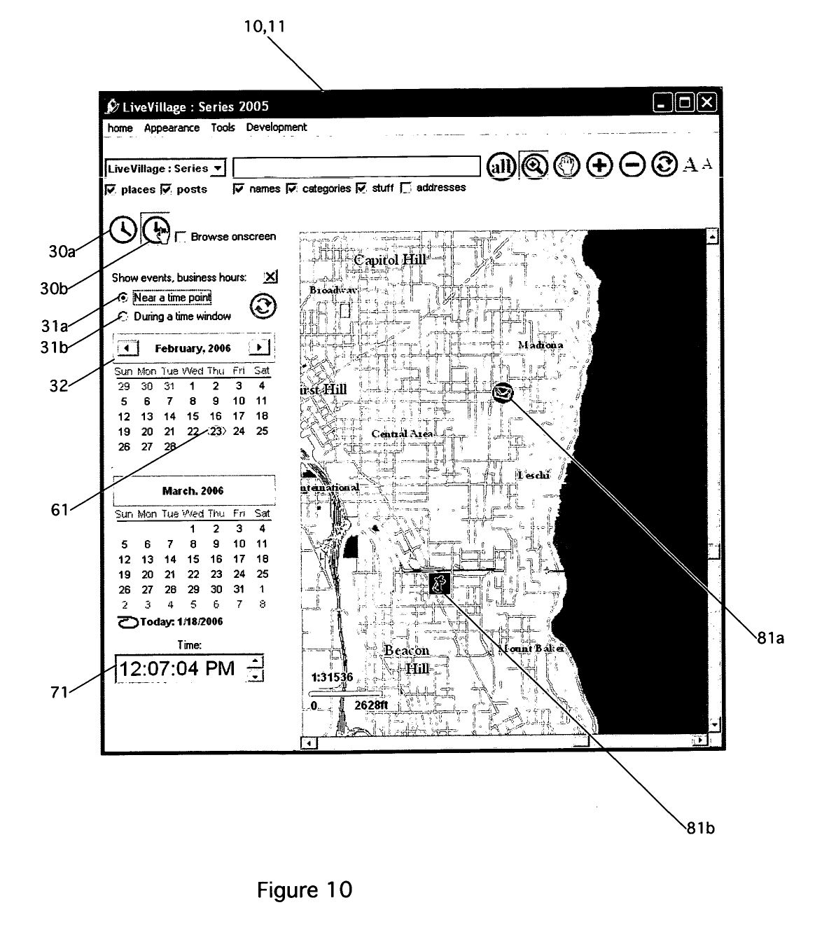

Referring to FIG. 10, the time condition has advanced to a time point on February 23. Relative to this time condition, event 81a is still a future event; and event 81b is in the past. But for event 81c of the previous figures, the mapping program has calculated derived information representing the amount of time since its time of ending relative the time condition, and has concluded that the event is far enough in the past relative the time condition that it should not be depicted on the map. Therefore event 81a remains unchanged in its manner of depiction; event 81b has changed to a “past” depiction, and event 81c is no longer depicted because it is relatively remotely in the past. Obviously many other ways of communicating a state of relative past remoteness could be employed without departing from the spirit and scope of the invention.

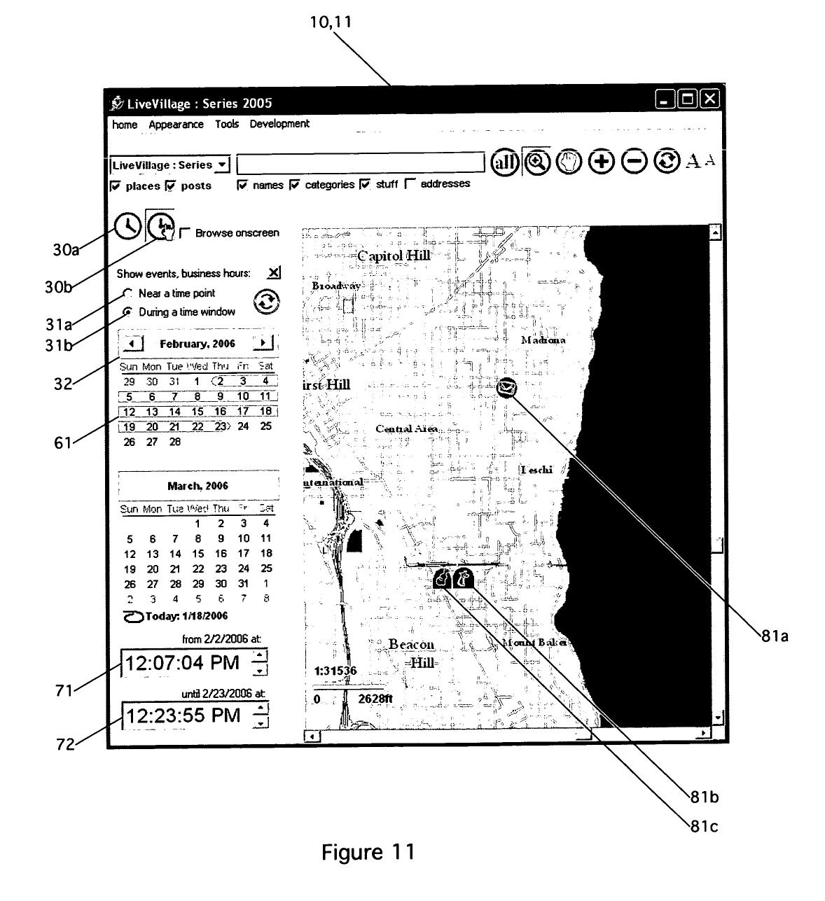

Finally, in FIG. 11, control element 30b has become activated and 30a has become inactive. Therefore a time period applies as the time condition, rather than a time point. Here the time period has been set to a range between a time point on Feb. 2, 2006 and a time point on Feb. 23, 2006. This range encompasses all of the time points that were shown in FIGS. 7-11. Therefore, all of the events that were found to be in occurrence in any of these previous figures are also found to be in occurrence during the time period of FIG. 11, because their time of occurrence falls within the time period that represents the time condition. Specifically, events 81b and 81c are depicted in an “occurrence” manner of depiction. Event 81c, because it is still in the future relative the end of the time condition (February 23), remains in a “future” depiction.

An alternate rule for assigning an indicated state for an event, relative a time-period-based time condition, might instead dictate that an event must be in occurrence for the full period of the time condition in order to be depicted as in occurrence. Many additional alternate rules are possible to be employed within the scope of the invention.

### EXAMPLE METHOD FOR REPRESENTING AND PROCESSING TIME-RELATED INFORMATION

A currently implemented method of representing and processing time-related information for the purpose of carrying out the invention is now described in detail. This method is also disclosed in my pending application for patent, “Time Conditioned Display of Time-Related Information Such as Hours of Operation for a Business”, filing date Jan. 5, 2006. Exemplification by means of this method is in no way restrictive of alternate methods that might be employed in carrying out the invention described herein.

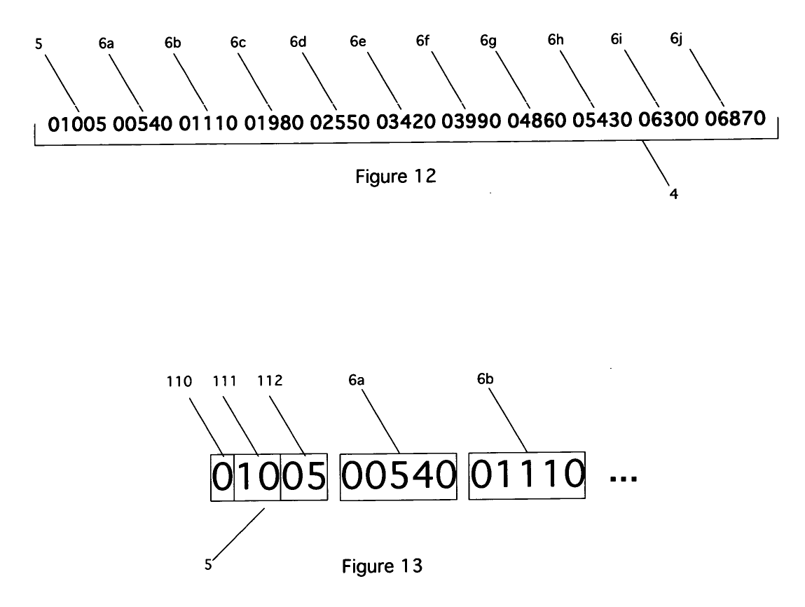

As is common in the art, when a digital mapping program seeks to compose a depiction of a mappable item upon the map display, it retrieves or references information, stored in an accessible place (such as a database, a disk location, or in computer memory), that describes the item to be mapped. Referring now to FIG. 12, said information may include one or more collections 4 of data groups 5-6j representing the time-related information pertinent to a given subject item. As further depicted by way of example in FIG. 12, the data group 5 represents meta information about the time-related information, and the data groups 6a-6j represent specific times (such as those of opening and closing) relative a base reference time pertaining to the applicable schedule style, as will be described below.

Referring now to FIG. 13, said meta information in data group 5 includes data 110 that represent an initial state (open or closed) to be associated with the period of time if any between the reference time and the first scheduled time in the list of opening and closing times. In this example, the value “0” represents an initial state of “closed”.

Optionally data group 5 may include additional data, such as for example data 111, representing the number of data groups 6a-6j present in the time-related information.

Data group 5 also includes data 112 representing a style of schedule period applicable to the time-related information. For example, hours of operation are preferably described in terms of a weekly repeating schedule period because business hours typically repeat on a weekly schedule such that a given day of the week always or almost always has the same opening and closing time. In the example of FIG. 13, the data 112 (“05”) are taken to represent a weekly schedule period denominated in minutes and having a base reference time set at 12:00 AM Monday. However it is possible that hours for some businesses might be representable on a different schedule period, in which case data 112 would be accordingly different. For example, a business that has the same schedule every day could be represented on a daily repeating schedule period rather than a weekly one. Alternatively a business that generally follows a weekly schedule but has numerous exceptions due to observance of annual holidays, might best be represented by means of a yearly repeating schedule. Therefore styles such as monthly, yearly, seasonal, daily, hourly, and many other styles are anticipated; also a nonrepeating schedule is anticipated in the case of time-related information describing a single occurrence of an opening/closing event, such as might exist, for example, for a business that opens and closes only once in history, or an event that occurs only once, or either of which occur on an irregular basis that cannot be represented by a repeating schedule and so can only be represented as a group of one-time occurrences.

Data groups 6a-6j represent a sequential series of scheduled opening and closing (or closing and opening) times during the schedule period. Here, each data group 6a-6j represents a time in minutes past a reference time associated with the style of schedule period specified in data group 5. For example, if the schedule period is weekly, the reference time might be established as 12:00 AM Monday, and all times 6a-6j expressed in terms of minutes elapsed since this reference time. In this example, scheduled times are encoded as integers (representing the number of minutes past the reference time) with leading zeroes added as necessary for padding to five digits. This format is for example only and many other suitable formats will be apparent to those skilled in the art. Ordering and format of all abovedescribed data and data groups may of course vary according to whatever manner is most convenient to those implementing the invention.

The system then performs evaluation of the time-related information with respect to the time condition in the following manner. An initial state is assigned equal to the initial state specified in data 110 (meta information). Times in the schedule (e.g. 6a-6j FIG. 12) are then sequentially compared to the time represented by the time condition. If the time represented by the time condition is later than the current schedule time and also later than the next schedule time, the state is flipped to the opposite state. In this way a “current” state is maintained during the process, representing the state entered into at the most recently examined schedule time, and preventing the need to explicitly associate “open” or “closed” state with each individual schedule time. When the time represented by the time condition is finally found to fall between two schedule times, the “current” state is taken as the indicated state, and the process halts. If no scheduled time precedes the time represented by the time condition, the initial state defined in the string is taken as the indicated state. An example of program code that implements this process is disclosed in my provisional application for patent 60/756,694, filing date Jan. 5, 2006. This process is claimed in my pending application for patent entitled “Time Conditioned Display of Time-Related Information Such as Hours of Operation for a Business”, filing date Jan. 5, 2006, and is cited here as an application.

The indicated manner of depiction of a mappable item may additionally be influenced by information derived from additional calculations relating to the indicated state and/or the time condition and/or the time-related information. For example, the evaluation process may also include checks for the condition in which the schedule indicates that a change in state from the indicated state is particularly near or particularly recent relative the time condition, and a measure of the relative nearness or recentness derived.

For example, in a circumstance in which the indicated state is found to be “open” at the time represented by a given time condition, but the state is scheduled to become “closed” within a particularly short period of schedule time after the time represented by the time condition, a measured may be derived and a depiction indicated that expresses the finding that although the item is currently in an open state, it may be expected to be in a closed state soon. Similarly, a business that is closed with respect to the time condition but scheduled to open in a relatively short amount of time afterward could result in derivation of a similar measure and receive a depiction that signals such a condition. As an example, anticipated impending closure of a business might be expressed by means of a flashing on and off of the item depiction, or a cycling of colors in which the depiction is painted, or by superimposition of a symbol suggesting impending closure such as a depiction of a clock face, or any number of other similar means by which said impending state might be communicated to the viewer. As anyone may see, this concept may also be applied to identifying and expressing similar time-related circumstances, such as might be suggested by the phrases “about to open”, “about to happen”, “about to end”, “just finished happening”, “a long time away”, “more than a day away”, “5 minutes away”, and so on.

For the purpose of quantifying such situations, anyone skilled in the art will now see that a specified or predetermined threshold time or percentage of time relative to a norm such as the duration of the next open period may be employed to calculate such a measure. The specific threshold or percentage or other relation to be employed for this purpose may be specified in the code of the digital mapping display program, or optionally could be retrieved from a location on the internet or on disk, or specified and received by the program as part of the time-related information, or specified by the user as a program option setting or via other user interface means. Additionally and optionally, to represent the actual amount of schedule time remaining until a change in state relative the time condition, or to represent the actual amount of time elapsed since the indicated state began, additional information may be returned and displayed, such as, for example, “will be open for another 3 hours and 15 minutes”, or “closed 3 hours and 15 minutes ago”, or “has been open for 2 hours”. Also additionally and optionally, to represent the actual time of the previous or next scheduled time relative the time condition, additional information may be returned such as “closing at 3:00 pm” or “opening at 9:00 am”.

Furthermore, the result of a time calculation expressing the amount of time before the next scheduled change of state or property, or since the previous scheduled change of state or property, may be employed in further calculations for the purpose of other representations, such as those that might depend on a function of how much time is remaining before a mapped event happens or stops happening.

The evaluation optionally includes calculation of derived information as follows: the amount of schedule time separating the immediately previous scheduled time (or the last scheduled time if the next scheduled time is the first time in the schedule) and the time represented by the time condition; the amount of schedule time separating the next scheduled time (or the first scheduled time if the previous scheduled time is the last time in the schedule) and the time represented by the time condition; the actual time of the next scheduled time; and the actual time of the previous scheduled time.

Those skilled in the art will recognize that other means are available to provide time-related information to the digital mapping program for the purpose of carrying out the invention. For example, an alternate method might involve referencing of an item identification number by the digital mapping program instead of the time-related information itself, and then using said number to look up the corresponding time-related information in a database.

It is also anticipated that other states may be returned corresponding to other potential situations other than “open” and “closed”. For example, a state such as “by appointment” or “hours vary” or “hours unknown” could be returned if the time-related information is found to indicate a variable or indeterminate schedule. This might be represented in the time-related information by means of a code provided in the meta information, or perhaps by omitting the schedule times from the time-related information, or perhaps by including a certain designated value as a schedule time, or by omitting time-related information, or in any other way that could be anticipated by those skilled in the art.

The abovedescribed method of evaluation is for example only and in no way restricts or limits the scope of the invention. Having learned of the abovedescribed method employed in the preferred embodiment(s), alternate methods of achieving representation of time-related information in computer memory, disk, or database; and of processing of said time-related information in order to identify and display indicated state(s) or propertie(s) corresponding to a time condition, will be apparent to anyone skilled in the art of computer programming and data structures.

### CONCLUSION, RAMIFICATIONS, AND SCOPE

The foregoing embodiments and examples are provided as illustrative examples of specific embodiments that fall within the spirit and scope of the invention, for the purpose of providing an understanding of the invention. They are not to be taken to fully delineate all potential implementations that fall within the scope of the invention. Anyone skilled in the art, upon learning of and understanding the specific examples described herein, may conceive other minor variations that would nevertheless fall within the spirit and scope of the invention claimed herein.

The basis for the time condition may take on a number of variations without departing from the spirit or scope of the invention. For example, the time condition may be a system time determined by the internal clock of the computer that drives the map display; or it may be a referenced time received from a time server representing real world time; or it may be a time other than the current time, as specified by a user or found in a database; or it may be a time computed from other information (such as, for example, the current time advanced by an estimated travel time from a specified, implied, or default location of the user of the map to the real world location of a mappable item). Furthermore the time condition may be a “fuzzy” or probabilistic time measure rather than a discrete time measure, as will be further noted later in this document.

The time-related information may be represented in a large variety of ways without departing from the spirit or scope of the invention. For the purpose of understanding this topic with regard to the scope of the invention, the important thing is that the time related information be sufficient to relate one or more specified, implied, or default states or properties of the item it describes to one or more specified, implied, or default time points or time periods within a specified, implied, or default time domain. The time domain preferably is either a recurring time period (such as a calendar week, calendar month, calendar year, or any other time basis), or a one-time point in time or time period (such as historical time relative to a specified, implied, or default base historical time origin point, for example Jan. 1, 1900).

While the foregoing discussion has primarily described application of the invention to business hours for a retail business and to one-time or repeating events taking place at a geographic location, the invention applies equally well to other types of time-related information. The invention covers the depiction of indicated state(s), propertie(s), or their probabilitie(s), pertaining to any subject that can possess time-related information that relates said attributes to time. Clearly this includes every sort of one-time or recurring event, such as happy hours, sales events, or any other type of one-time or recurring phenomenon for which states, properties, or probabilities of said states or properties are representable as a function of time, described on a one-time basis or on the basis of any repeating schedule including but not limited to weekly, monthly, yearly, millennial, or any other basis.

The invention also applies to depiction of items having time-related information descriptive of movement in position or orientation relative to the geographic basis of the map display. In this way the invention extends to the depiction of a mappable item in an indicated map location resulting from the evaluation of its time-related information relative the time condition. That is, it is anticipated that the state(s) or propertie(s) related to time by said time-related information may include geographic location of the item as a function of time. The invention thereby explicitly includes depiction of movement of items along a scheduled route. In such an application, anyone skilled in the art, having become aware of the advantages of the invention in this regard, may conceive of a number of ways to represent time-related information associated with such mappable items sufficient for the invention to depict them on the map display. For example, the time-related information might comprise a finite series of pairs of values representing a plurality of scheduled times and their corresponding scheduled locations. The invention might then interpolate between said pairs in order to achieve estimation of intermittent locations at specific times between said time/location pairs, thereby computing incremental movement of mapped items between the points represented by the pairs, without requiring the time-related information to fully enumerate all possible time points and their corresponding locations.

Furthermore, it is anticipated that the time condition may be automatically advanced or regressed to simulate passage of time forward or backward at a realistic (i.e. natural) pace, or a faster pace, or a slow-motion pace, so that the resultant changing of indicated state(s), propertie(s), or their probabilitie(s) as the time condition automatically changes may be depicted and revised continually in an animated manner on the digital map display. This animated embodiment would have the advantage of providing continual update of changes in states or properties of mapped items over time, without requiring the user to continually refresh the map display.

Another variation would apply an offset to whatever time is established as a basis for the time condition in order to modify the time to represent some time in the future or in the past. For example, the current system time might be used as an initial basis and then, prior to its application to the task of determining the indicated state or property of a given mappable item, it may be modified by a time offset representing an expected travel time from the user's known, specified, computed, or sensed location, to the real-world location of the given mapped item. In this way, any number of mapped items may be portrayed in a way expressing an expected state or property that would be encountered if the user or viewer of the map display were to travel to a given mapped item. In this case some or all of the mapped items would have been evaluated with respect to a unique time condition as necessary to represent an expected time of arrival to each respective mapped item's real world location. For example, if the user is located in a geographic location that is ten minutes' estimated travel time from the region depicted by the map display, and it is established that the current system time is to be used as a basis for the time condition, indicated states or properties of mapped items might be identified with respect to a time condition ten minutes past the current system time. Alternatively, if for example the user is located in a geographic location corresponding to an edge of the region depicted by the map display, indicated states or properties of each individual mapped item might be identified with respect to a number of different time conditions, each corresponding to the current system time plus an estimated travel time to a given individual item.

In the foregoing examples it was shown that time related information could be represented by a series of values describing certain meta information and a sequence of weekly times in minutes. The invention is not limited to this specific format or medium and it is apparent that the invention could employ any other valid format without departing from the spirit or scope of the invention. Also as previously mentioned, time-related information may be looked up in a database as needed, rather than directly represented in this format in memory.

The meta information data group may carry additional information in addition to that already described. As an example, it could include information representing the specific states to be associated with the sequence of times represented in the data. In the previous discussion, it was assumed that the binary states associated with the initial state and the schedule times were “open” and “closed”. In the example provided in this disclosure, these states were not represented explicitly in the meta information because the digital mapping program was taken to assume these states as applicable. However, in a more diverse application where other binary states such as for example “hot” and “cold”, or “staffed” and “unstaffed”, are possible, the meta information could include a code representing which binary pair is applicable, in the same manner that the previous description of the meta information included a code representing schedule style.

In addition to binary states such as “open” and “closed”, many other binary states may be related to time by the time-related information. For example, the states could correspond to “exists” and “does not exist” as suggested previously. Additionally the states need not be binary pairs. For example, for one-time events, three mutually exclusive states are possible, including “future”, “happening now”, and “past”. Additionally any number of alternative mutually exclusive states, such as “red”, “yellow”, “green” may be employed. Furthermore the states do not need to be mutually exclusive. For example, at a given time condition more than one state may apply, such as “cloudy”, “warm”, and “not raining”. In these non-binary or non-mutually exclusive cases, the time-related information would need to include meta information explicitly indicating which state each schedule time relates to, and whether it initiates the state or ends the state. Having become familiar with the invention, anyone skilled in the art may conceive of data formats and techniques to accomplish this.

The meta information could be omitted entirely without departing from the spirit or scope of the invention, if for example the meta information is instead retrieved from a database rather than carried in the representation.

In the foregoing examples, schedule times represented in the time-related information were denominated in minutes past a reference time applicable to the schedule style. In other variations, schedule times may be denominated in any unit of time, such as minutes, seconds, hours, days, millennia, milliseconds, and so on. The specific unit to be associated with a given piece of time-related information may be indicated by means, for example, of a code in the meta information data group, a code attached to each data group representing a schedule time, or embodied in the code of the digital map display program.

While a preferred user interface means for user-specification of information to be used in establishing the time condition was described in this disclosure, this function may be provided in any way commonly known in the art, for example, via an interactive form and edit box provided on an information display such as a web page; edit boxes, radio buttons, pull-down or pop-up menu, checkboxes, etc; an interactive depiction of a clock; an interactive depiction of a calendar; or any other suitable method of user input known in the art of interface design. The information thus specified may comprise date and/or time information, or alternatively, may be a selection from a set of established types of prepackaged time conditions, such as “tonight”, “tomorrow”, “this weekend”, etc.

As suggested in the examples, the time condition employed for determining indicated state(s) or propertie(s) may be a default time such as for example current system time, or localized current system time, or a fixed or variable time related or unrelated to current time; or a user-specified time; or a default time modified by an offset specified by the user; or a default time modified by a default offset, or a current or user-specified time modified by an offset derived from an estimated travel time from the user's specified or detected location to the location of the subject, or similar combinations.

It is also anticipated that the time-related information may include so-called “fuzzy” specification of time point(s) or interval(s) rather than exact (discrete) values. That is, the time values may be represented by a set or continuum of probabilities for expecting a given state at a given time, rather than a set of discrete step changes of state at specified instants of time. This may also be accomplished by representing the time-related information in the form of a continuous function, or alternatively a step function, or a combination of the two, that relates probabilities of states or properties to time. In this way, changes of state or property that are probabilistic in their predictability may be represented. For example, a business operated on an informal basis might vary in its actual opening time by plus or minus twenty minutes, having some definable probability of being open or closed at any given time point near the scheduled opening time. In the case of “fuzzy” time-related information such as this, rather than determining indicated state(s) or propertie(s) to be employed in determining a manner of depiction of an item, the system would preferably determine probabilities for the one or more state(s) or propertie(s) that are possible at the time or time period specified by the time condition. For example, the determination might be 20% probability of “closed” and 80% probability of “open”. Accordingly this information may be used in determining a manner of depiction expressive of the probabilitie(s). For example, a business judged in this way to have an 80% probability of being open at the time condition, might for example be depicted at 80% of the brightness of coloration that would be assigned to a 100% open depiction, or at a depicted size 80% of the size that would be assigned to a 100% open depiction, or any number of other ways similarly expressive of relative or absolute probability.

It is also anticipated that the time condition may be specified in a similarly “fuzzy” way, so as to allow determination of probabilities of states or properties as described above, either in evaluation relative a discrete style of time-related information, or a “fuzzy” style of time-related information. That is, the invention includes the possibility of having either, both, or neither of the time condition and the time-related information being represented in a “fuzzy” way as described.

The invention may also be applied to information displays other than a digital map display. For example, any computer display or other information display that seeks to depict any representation of an item that possesses time-related information as discussed herein, said representation or depiction being made in a manner influenced by indicated state(s) or propertie(s) (or their probabilitie(s)) of said item as described herein, is operating on the principle of the invention.

One example of such an embodiment would take the form of a tabular representation rather than a traditional digital map; said tabular representation having a rectangular form in which one dimension represents an interval of time, while the other dimension hosts a list or other representation of geographic location (such as a list of businesses). A plurality of cells interior to the two said dimensions, being inherently intersections of the two said dimensions, thereby each represent a given geographic location during a given period of time and therefore may be colored or otherwise modified to express a state or property of a displayable item. For example, said cells or contiguous groups of said cells that correspond to derived information (such as the times of beginning and end of an event at a listed business) may be colored or otherwise modified so as to communicate the occurrence of said event during the time interval and at the geographic location represented by said cells or said groups of cells.

For the purpose of disclosure of the invention, the foregoing discussion focused particularly on an embodiment in which a dynamically generated digital map running on a desktop computer employs coloration and/or symbolization as a means of varying manner of item depiction in response to indicated state or property. Clearly, the invention extends to other embodiments, such as for example, a web page that shows a map of businesses, with status depicted by means of the depicted appearance of each mapped business. The foregoing examples have been provided for illustrative example purposes in order to give a sense of the breadth of applicability of the invention, and do not restrict the spirit and scope of the invention, as anyone skilled in the art may now anticipate additional applications that may employ the invention.

I claim:

1. A method for composing the display of a digital map, comprising:
establishment of a time condition,
association of said time condition with a digital map display or at least one instance of composing said display,
reference to time-related information pertaining to at least one mappable item, said time-related information relating at least one state or property of said mappable item to at least one time point or time period within a time domain;
identification of at least one indicated state or property of said mappable item as corresponding to said time condition, said identification by means of evaluation of said time-related information relative said time condition;
depiction of said mappable item on said map display in a manner dependent at least in part upon said indicated state or property.

2. The method of claim 1 wherein said time condition is a time point, or a time point representing current system time, or a time point representing current system time localized to the geographic region pertaining to at least one mappable item, or a time period comprising a start time point and an end time point, or a base time point offset by a fixed quantity of time, or a base time point offset by an estimated travel time from the geographic location of the user to the geographic location of at least one mappable item.

3. The method of claim 2 wherein said time condition is established by reference to a user interface by which said time condition may be specified by a user of the digital map.

4. The method of claim 2 wherein: (a) said evaluation further includes the derivation of derived information derived from the relationship between said time-related information and said time condition, said derived information including any combination of: the amount of time between any time point comprising the time condition and the time of the next scheduled change of state or property; the amount of time between any time point comprising the time condition and the time of the previous scheduled change of state or property; the scheduled time of said next scheduled change of state or property; the scheduled time of said previous scheduled change of state or property; a measure of the degree of nearness in time of said next scheduled change in state or property relative to any time point comprising the time condition; a measure of the degree of nearness in time of said previous scheduled change in state or property relative to any time point comprising the time condition; and (b) said depiction further includes depiction of said mappable item on said map display in a manner dependent upon the derived information.

5. The method of claim 2 wherein said state or property is state or property of a scheduled availability of said item, or is state or property of historical existence of said item, or is state or property of geographic location of said item.

6. The method of claim 2 wherein said item is a place of business, said state or property is representative of a scheduled open and closed status of said place of business, and said manner of depiction includes differential coloration of the depiction of said place of business on said map display.

7. The method of claim 2 wherein said item is an event, and said state or property is representative of a status of the event as being past, future, or current, relative said time condition.

8. The method of claim 2 wherein said time condition is automatically changed in a manner suggestive of a simulated passage of time.

9. The method of claim 1 wherein said time condition is automatically changed in a manner suggestive of a simulated passage of time.

10. A digital map display apparatus comprising:
a digital map display means;
storage means for a time condition, said time condition being thereby associated with said map display or at least one instance of composing the map display;
a database representing at least one item mappable on said display;
time-related information contained in said database, said time-related information relating at least one state or property of at least one mappable item to at least one time point or time period within a time domain;
identifying means for identifying at least one indicated state or property of at least one mappable item as corresponding to said time condition, by means of evaluation of said time-related information relative said time condition;
depicting means for representing said mappable item on said map display, so as to represent said item in a manner of depiction dependent at least in part upon said indicated state or property.

11. The apparatus of claim 10 wherein said time condition is any time point, or a time point representing current system time, or a time point representing current system time localized to the geographic region pertaining to at least one mappable item, or a time period comprising a start time point and an end time point, or a base time point offset by a fixed quantity of time, or a base time point offset by an estimated travel time from the geographic location of the user to the geographic location of at least one mappable item.

12. The apparatus of claim 11 additionally including a user interface means by which said time condition is able to be specified by the user of the apparatus.

13. The apparatus of claim 11 wherein: (a) said evaluation means additionally includes deriving means for derived information derived from the relationship between said time-related information and said time condition, said derived information including any combination of: the amount of time between any time point comprising the time condition and the time of the next scheduled change of state or property; the amount of time between any time point comprising the time condition and the time of the previous scheduled change of state or property; the scheduled time of said next scheduled change of state or property; the scheduled time of said previous scheduled change of state or property; a measure of the degree of nearness in time of said next scheduled change in state or property relative to any time point comprising the time condition; a measure of the degree of nearness in time of said previous scheduled change in state or property relative to any time point comprising the time condition; and (b) said depicting means additionally comprises depiction of said mappable item on said map display in a manner dependent upon the derived information.

14. The apparatus of claim 11 wherein said state or property is state or property of a scheduled availability of said item, or state or property of historical existence of said item, or state or property of geographic location of said item.

15. The apparatus of claim 11 wherein said item is a place of business, said state or property is representative of a scheduled open and closed status of said place of business, and said manner of depiction includes differential coloration of the depiction of said place of business on said map display.

16. The apparatus of claim 11 wherein said item is an event, and said state or property is representative of a status of the event as being past, future, or current, relative said time condition.

17. The apparatus of claim 11 wherein said time condition is automatically changed in a manner suggestive of a simulated passage of time.

18. The apparatus of claim 10 wherein said time condition is automatically changed in a manner suggestive of a simulated passage of time.

19. A method for representation of items on a computer display, comprising:
establishment of a time condition consisting of a start time point and an end time point,
association of said time condition with said computer display or at least one instance of composing said computer display,
reference to time-related information pertaining to at least one displayable item, said time-related information relating at least one state or property of said displayable item to at least one time point or time period within a time domain,
derivation of derived information derived from the relationship between said time-related information and said time condition, said derived information including one or both of (a) the amount of time between any time point comprising the time condition and the time of the next scheduled change of state or property, and (b) the amount of time between any time point comprising the time condition and the time of the previous scheduled change of state or property,
depiction of said displayable item on said computer display in a manner expressive of at least said derived information.

20. The method of claim 19 wherein said computer display is a two-dimensional tabular depiction comprising:
a first dimension, representing a period of time corresponding to a time interval defined by said start time point and said end time point of said time condition,
a second dimension, upon which is listed at least one geographic location corresponding to at least one displayable item,
an interior area defined by said two dimensions, upon which said depiction of said displayable item is made,
said depiction including an area, cell, or group of cells bounded in said first dimension by said derived information being plotted in the first dimension, and bounded in said second dimension by the extent in that dimension of the listed geographic location of said displayable item.
